(19) United States
(12) Patent Application Publication
(10) Pub. No.: US 2012/0279110 A1
(43) Pub. Date: Nov. 8, 2012

(54) BAIT DISPENSER FOR MICE AND RATS

(76) Inventor: Giorgio Finotello, Padova (IT)

(21) Appl. No.: 13/516,074

(22) PCT Filed: Dec. 13, 2010
(86) PCT No.: PCT/EP2010/069471

§ 371 Date: Jul. 19, 2012

(30) Foreign Application Priority Data
Dec. 22, 2009 (IT) PD2009A000387

(51) Int. Cl. A01M 25/00

(52) U.S. Cl. 43/131

(57) ABSTRACT

A dispenser (T) of rat-poison bait comprising a housing that contains a rat-poison bait (E), the housing being formed from a sheet (F) which is die-cut, folded and glued or heat-sealed at one or more points (Qi), the sheet (F) making up, on its own or in conjunction with other sheets or other heat-formed elements, walls (T21, T22, T11, T12), a bottom (T4) and a top (T3) and one or more separating internal walls (S1, S2), and wherein on one or more of the walls (T11, T12, T21, T22) and/or separating internal walls (S1, S2) at least one hole or opening (A1, A2, P1, P2) is provided for the passage of mice or rats or small rodents in general.

### TECHNICAL FIELD

The present invention relates to bait dispensers for mice and rats, and in particular it relates to a new, disposable bait dispenser for mice and rats, for predominantly domestic or residential use, indoors and outdoors.

### BACKGROUND ART

Bait dispensers for mice and rats are known which comprise a box or container inside which at least one activated bait is located and fixed.

Baits are known which cause the death of the rodent a few days after ingestion, so as to not arouse wariness of the bait in other rodents.

Bait dispensers are known that are defined by a T-shaped container that comprises a first cylindrical portion, with open ends so that the mice or rats to enter, and a further cylindrical portion which is arranged transversally to, and is connected with one end with, the first cylindrical portion, so as to form a corridor that can be traversed by the rodent.

The transversal cylindrical portion is provided at its free end with opening/closing means for inserting the bait.

Containers are also known which are in the form of a box with its bottom, side walls and top closed, while the ends have one or more openings for the rodent to access the box.

The box is defined by two shells which are movable with respect to each other and can be opened in order to insert the bait and fix it to the inside, and then closed again by means of closing means which prevent its being reopened by for example children or non-targeted animals.

These means of closing the bait dispensers of known types comprise for example locks or padlocks with a key, and this key has to be kept for each subsequent reuse of the dispenser and it also has to be stored in a safe place, out of the reach of children who might use it to open the dispenser and handle the bait.

The known bait dispensers of this type also have the drawback that the user has to handle the bait in order to place it inside the container or to replace it.

In the known bait dispensers, the rodent access opening is in general at least a couple of centimetres in diameter in size.

Therefore, pets such as cats or small dogs are able to put a paw inside the dispenser through the opening and so touch the bait, which might be at least partly eaten by the animal, with serious consequences for its health.

A child could also access the bait by putting his or her fingers inside the box.

Moreover, a larger animal, such as a medium-sized dog, could bite into the whole box, which measures five to six centimetres on a side, thus ingesting the bait.

Moreover, actions by non-targeted animals or by children which might interfere with the bait limit the effectiveness of the dispenser because the mice or rats might detect the unfamiliar smells and become wary of the bait.

In order to overcome all of the above mentioned drawbacks, a new type of bait dispenser for mice and rats has been designed and made, for predominantly domestic or residential use, indoors and outdoors.

### DISCLOSURE OF THE INVENTION

The principal aim of the present invention is to minimize the risk of interference with and ingestion of the bait by other, non-targeted animals or by children.

Within this aim, an object of the present invention is to ensure the maximum effectiveness of rodent pest elimination.

Another object of the present invention is to make the condition of the bait immediately visible to the user, so that the dispenser can be promptly replaced when the bait has been eaten.

Another object of the present invention is to make the bait dispenser ready for use and disposable, so that the user never has to touch the bait in any way.

Another object of the present invention is to simplify the procedures of making and packaging the dispenser itself.

This aim and these and other objects, both direct and complementary, are achieved by the new disposable bait dispenser for domestic and residential use, which comprises, in its principal parts, at least one sheet which is folded so as to define, on its own or in conjunction with other sheets or heat-formed elements, a container that comprises a bottom, at least two side walls, at least two end walls, a closed top and one or more internal separation walls, and wherein on one or more of said walls, preferably on the end walls, at least one hole or opening is provided for the entry and exit of mice and/or rats.

The inside of this container is subdivided into at least two chambers by means of separating internal walls, and in particular at least one main chamber which does not communicate directly with the openings for rodent access, and at least one antechamber which communicates both with the main chamber, through at least one opening which is provided on the internal separation wall and is adapted to allow the passage of rodents, and also directly with the outside world through the rodent access opening.

The main chamber is adapted to accommodate inside it at least one rat-poison bait, this bait being adequately coupled to the inside of the main chamber itself.

The rodent access openings inside the housing are preferably obtained by the removal of at least one closed portion, whereby the portion can be pre-cut and torn out, or generically applied or glued at the opening.

The antechamber has dimensions which are such that the distance between the rodent access opening and the passage through to the main chamber is such as to prevent a small to medium size pet, such as a cat or a small dog, from reaching the bait with its paw.

Similarly, the risk is minimized that a child could, by inserting a finger into the antechamber, reach the inside of the main chamber and therefore the bait.

Moreover, the overall dimensions of the bait dispenser are such that a medium to large animal, such as a large dog, cannot ingest the housing.

The bait dispenser according to the invention is preferably of the ready-to-use type, i.e. made available to the user with the bait already inserted in the main chamber.

The bait dispenser according to the invention is also preferably of the disposable type, i.e. when the bait has been consumed, the user has merely to discard the entire housing. The user, moreover, never has to handle the bait and does not come into contact with any fragments of poisonous bait or with any rodents that become stuck inside the housing.

It is possible to see inside the main chamber, for the purposes of checking the condition of the bait. In the preferred embodiment, at least one portion of one or more of the side walls or of the top, at the main chamber, is transparent or semitransparent, while the remaining portions are preferably opaque or printed, in order to facilitate the rodent's entry and its access right up to the main chamber.

The bait dispenser according to the invention is preferably made from at least one sheet of die-cut plastic material, which is adapted to be folded along the perforated lines and glued so as to form a three-dimensional housing, where the sheet itself makes up the side walls, the end walls, the top, the bottom and preferably also the internal dividing walls which separate the chambers.

The bait dispenser of the invention made with plastic sheet is particularly adapted for outdoor use, being substantially waterproof. The new bait dispenser, if made with cardboard sheet, is adapted for indoor use.

In order to use the bait dispenser, it is sufficient to remove the closed portions of the access openings and place the housing where necessary, coupling it for example by means of double-sided adhesive tape.

### BRIEF DESCRIPTION OF THE DRAWINGS

The characteristics of the bait dispenser according to the invention will become better apparent from the following description with reference to the accompanying drawings, enclosed for the purposes of non-limiting example.

FIG. 1 is a perspective view of the bait dispenser (T) of the invention, while

FIG. 2 is a schematized plan view of a section through the bait dispenser (T).

### WAYS OF CARRYING OUT THE INVENTION

The disposable bait dispenser (T) for domestic and residential use comprises, in its principal parts, at least one sheet (F) which is folded so as to define a three-dimensional housing that comprises a bottom (T4), two side walls (T21, T22), two end walls (T11, T12), and a closed top (T3), and wherein on one or more of the walls, preferably on each of the end walls (T11, T12), at least one hole or access opening (A1, A2) is provided for the entry and exit of mice and/or rats.

In the preferred embodiment, the housing is formed from a single sheet (F) which is die-cut and folded and furthermore the bottom (T4) and/or the top (T3) and/or the end walls (T11, T12) are stiffened, being formed from at least two portions of the sheet (F) which are folded and overlaid.

The inside of this housing is subdivided into at least two chambers (C1, C2, R) by means of separating internal walls (S1, S2), and in particular it comprises at least one main chamber (R) which does not communicate directly with the openings (A1, A2) for rodent access, and at least one antechamber (C1 or C2) which communicates with the main chamber (R), through at least one opening (P1, P2) which is provided on the separating internal wall (S1, S2) and is adapted to allow the passage of rodents.

The antechamber (C1, C2) also communicates directly with the outside world through the rodent access opening (A1, A2). Accommodated inside the main chamber (R) there is at least one rat poison bait (E), which is adequately coupled to the inside of the chamber (R) so as to not be able to accidentally leave the main chamber (R).

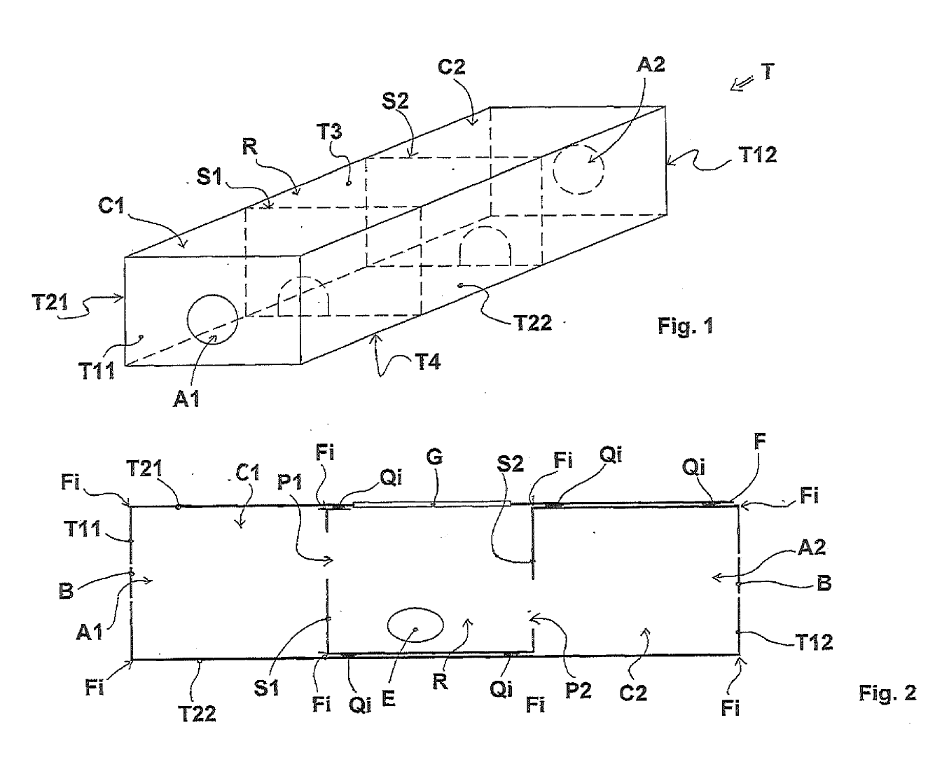

In the preferred solution, shown in FIGS. 1 and 2, the dispenser comprises a main chamber (R) which communicates with two antechambers (C1, C2) which are symmetrically arranged at the two opposite sides of the main chamber (R).

The main chamber (R) communicates with each of the two antechambers (C1, C2) through at least one passage opening (P1, P2). Each of the antechambers (C1, C2) also communicates directly with the world outside the housing through at least one respective access opening (A1, A2).

The access openings (A1, A2) and the internal passage openings (P1, P2) are aligned or preferably not aligned, so as to further minimize the risk that children and/or non-targeted animals could reach the bait inside the main chamber. Moreover it has been shown that the “labyrinth” configuration of the access openings (A1, A2) and the passage openings (P1, P2) between the chambers (C1, C2, R) more easily induces the rodent to enter the dispenser through an access opening (A1 or A2) and to pass through all of the chambers (C1, C2, R) towards the other access opening (A2 or A1), thus also visiting the main chamber (R) and thus the bait (E).

In the preferred solution, the dispenser (T) is obtained from a sheet (F) of die-cut plastic material or cardboard, which is adapted to be folded along the perforated lines (Fi) and glued or heat-sealed at one or more points (Qi) so as to form the three-dimensional housing.

The sheet (F) itself makes up the side walls (T21, T22), the end walls (T11, T12), the top (T3), and the bottom (T4) of the housing and the separating internal walls (S1, S2) which separate the chambers (C1, C2, R).

In the preferred embodiment, for the purposes of being able to see the inside of the main chamber (R), in order to check the condition of the bait (E), at least one portion (G) of one or more of the side walls (T21, T22) or of the top (T3), at the main chamber (R), is transparent or semitransparent, while the remaining portions are preferably opaque or printed.

Moreover, the access openings (A1, A2) of the dispenser (T) are obtained by removal of a closed portion (B), this portion (B) being precut or applied, for example glued, on the sheet (F). These schematic methods are sufficient for the technician skilled in the art to implement the invention, and consequently, in the real-world application there can be variations that do not prejudice the substance of the appended claims.

In addition, all the details can be substituted by other technically equivalent elements.

1. A dispenser (T) of rat-poison bait for domestic or residential use, comprising a three-dimensional housing which is adapted to contain at least one rat-poison bait (E), said housing in turn comprising a bottom (T4), two side walls (T21, T22), two end walls (T11, T12) and a closed top (T3), characterized in that said housing is formed from a die-cut sheet (F), which is adapted to be folded and glued or heat-sealed at one or more points (Qi), said sheet (F) making up, on its own or in conjunction with other sheets or other heat-formed elements, walls (T21, T22, T11, T12), a bottom (T4) and a top (T3) and one or more separating internal walls (S1, S2), and wherein on one or more of said walls (T11, T12, T21, T22) and/or separating internal walls (S1, S2) at least one hole or opening (A1, A2, P1, P2) is provided for the passage of mice or rats or small rodents in general.

2. The rat-poison bait dispenser (T) of claim 1, characterized in that the inside of said housing is subdivided, by means of said separating internal walls (S1, S2), into at least two chambers (C1, C2, R), of which there is:
at least one main chamber (R) which is adapted to accommodate said rat poison bait (E) and does not communicate directly with said openings (A1, A2) for access by the rodents;
at least one antechamber (C1 or C2) which communicates with said main chamber (R), through at least one opening (P1, P2) for the passage of rodents which is provided on said separating internal wall (S1, S2), and communicates with the outside world through said rodent access opening (A1, A2).

3. The rat-poison bait dispenser (T) according to claim 1, characterized in that said housing is formed from a single sheet (F) which is die-cut and folded.

4. The rat-poison bait dispenser (T) according to claim 1, characterized in that said bottom (T4) and/or said top (T3) and/or said end walls (T11, T12) are stiffened, being formed from at least two portions of said sheet (F) which are folded and overlaid.

5. The rat-poison bait dispenser (T) according to claim 2, characterized in that it comprises said central main chamber (R) which communicates with two antechambers (C1, C2) which are symmetrically arranged on the two opposite sides of the said main chamber (R), and wherein said main chamber (R) communicates with each of the two antechambers (C1, C2) through at least one passage opening (P1, P2), while each of said antechambers (C1, C2) communicates with the world outside the dispenser (T) through at least one respective access opening (A1, A2).

6. The rat-poison bait dispenser (T) according to claim 1, characterized in that two or more of said access openings (A1, A2) and of said passage openings (P1, P2) are aligned.

7. The rat-poison bait dispenser (T) according to claim 1, characterized in that said access openings (A1, A2) and said internal passage openings (P1, P2) are not aligned.

8. The rat-poison bait dispenser (T) according to claim 2, characterized in that at least one portion (G) of one or more of said side walls (T21, T22) or of said top (T3), at said main chamber (R), is transparent or semitransparent, for the purposes of being able to see the inside of said main chamber (R), in order to check the condition of the bait (E).

9. The rat-poison bait dispenser (T) according to claim 1, characterized in that said sheet (F) is made from plastic material.

10. The rat-poison bait dispenser (T) according to claim 1, characterized in that it is disposable.

11. The rat-poison bait dispenser (T) according to claim 2, characterized in that said rat-poison bait (E) is placed inside and coupled to the inside of said main chamber (R) before the housing is permanently closed.

12. The rat-poison bait dispenser (T) according to claim 1, characterized in that said access openings (A1, A2) are obtained by removal of a closed portion (B), said portion (B) being precut or applied on said sheet (F).
